(19) United States
(12) Patent Application Publication
(10) Pub. No.: US 2012/0132835 A1
(43) Pub. Date: May 31, 2012

(54) Control Valve for Pressure Reduction

(75) Inventors: Volker Richter, Regensburg (DE); Torsten Runge, Straubing (DE)

(73) Assignee: KRONES AG, Neutraubling (DE)

(21) Appl. No.: 13/307,189

(22) Filed: Nov. 30, 2011

(30) Foreign Application Priority Data
Nov. 30, 2010 (DE) 102010062195.1

(51) Int. Cl. F16K 7/04

(52) U.S. Cl. 251/7

(57) ABSTRACT

A control valve for pressure reduction, in particular for liquids containing solids and having an inlet, an outlet and a channel between the inlet and outlet, wherethe channel is formed as an elastic through-flow channel with a free line cross section which can be reduced along its longitudinal axis over an extended line section.

### CROSS-REFERENCE TO RELATED APPLICATION

The present application claims the benefit of priority of German Application No.102010062195.1, filed Nov. 30, 2010. The entire text of the priority application is incorporated herein by reference in its entirety.

### FIELD OF THE DISCLOSURE

The disclosure relates to a control valve for pressure reduction, in particular for liquids containing solids.

### BACKGROUND

A control valve of this nature is known, for example, from DE 11 2005 000 683 T5. It comprises two chambers with inlet and outlet and a channel connecting the two chambers, which is closed off by a partition device—here a membrane under pressure from a spring. When the pressure of the product in the inlet is greater than the pressure from the spring, the partition device opens a small gap in the channel and the liquid can flow into the discharge chamber. On flowing through the gap the pressure of the liquid is reduced over a very short distance. When valves of this nature are employed in food technology for liquid foodstuffs such as soft drinks, teas or juices which include solid constituents, for example fibers, juice sacks or fruit cells, these solid constituents are subjected to high mechanical shear stresses on passing through this gap, which can result in impairment of the quality or taste of the product.

### SUMMARY OF THE DISCLOSURE

One aspect of the disclosure is therefore to make a control valve available, which can be employed particularly in the foodstuffs industry for liquids containing solids, such that it ensures in a simple and gentle manner that the increased pressure on the product is reduced with as little mechanical stress as possible.

According to the disclosure this is achieved with a generic valve in that the connecting channel is formed as an elastic through-flow channel with a free line cross section, which can change—in particular however it can be reduced—along its longitudinal axis over an expanded line section.

If a product subjected to high pressure flows through the reduced line cross section of the through-flow channel formed as an expanded line section, the flow velocity of the product increases due to volume conservation, whereby a purely physical pressure reduction can be achieved. The pressure reduction of the product however occurs gradually over the extended line section, whereby the mechanical stress for the product can be kept low due to the long through-flow line cross section in the through flow channel. Due to the large free cross section of the line carrying the product, the shear stress of the product can be significantly reduced.

Preferably the control valve can comprise a housing in which the inlet, outlet and the channel are arranged, whereby the channel connects the inlet and the outlet. The channel is formed as an elastic through-flow channel which is coupled to the normal product line. In this way a stable mounting and a reliable interaction of the components of the control valve is achieved.

In a further preferred embodiment a control piston, extended along the longitudinal axis, is arranged on the control valve, which can be moved by at least one, preferably two, variable speed drives, which can be arranged on the housing. Control of the variable speed drives can be provided by a controller.

In a further preferred embodiment at least two control pistons, extended along the longitudinal axis, are arranged on the control valve. Each control piston can be moved independently of the others with the aid of at least one variable speed drive. Control of the variable speed drives can be provided by a controller. Due to a plurality of control pistons of this nature the piston area which becomes effective can be varied and adapted to the product.

Preferably the control pistons are movable in a direction vertical with respect to the through-flow channel. During the movement of one or a plurality of control pistons at least also in the vertical direction relative to the through-flow channel the piston area interacts with the elastic through-flow channel and the housing, so that the free line cross section of the through-flow channel is modified. Movability in the vertical direction is taken to mean that at least part of the control piston is movable at least also in the vertical direction opposite the longitudinal axis. In this respect a movement may also be involved which is diagonal with respect to the vertical direction or a pivoting movement with respect to a specific axis may be involved. It would however also be possible that the control piston acts on a further element, say a membrane, and presses it against the through-flow channel. In this case the membrane can also be used for the dynamic sealing of the through-flow channel and may thus also be a constituent part of it.

The use of a single control piston represents a simple and economical method of changing the free line cross section of the through-flow channel. By using a plurality of control pistons however a specified cross-sectional profile can be impressed in the through-flow channel. Thus it is for example possible to define a cross-sectional profile such that it is matched to a certain product solid-body size.

In a further advantageous embodiment the control valve is designed such that the line section has an internal diameter of 16-130 mm. In particular a minimum internal diameter of more than 16 mm is used so that on one hand the free line cross section is sufficiently large and variable and on the other hand the volume flows required for production are achieved.

In a further advantageous embodiment the control valve is designed such that the line section has a length of up to 0.3-3 m. In particular the line section has a minimum length of more than 0.3 m so that the product pressure is reduced over a sufficiently long run.

In a further advantageous embodiment the control valve is designed such that a pressure reduction of the product of up to 10 bar can be obtained. The control valve is used here especially for the reduction of pressure differences of 1.5 bar and more.

brief description of the drawings

In a further advantageous embodiment the control valve is designed such that it can process a volume flow of up to 90 m3/h. The control valve is used here especially for the processing of volume flows of 1 m3/h and more.

### BRIEF DESCRIPTION OF THE DRAWINGS

Further advantages and embodiments emerge from the enclosed drawings. These show:

FIG. 1 a schematic side view of a control valve according to the disclosure;

FIG. 2 a cross-sectional representation of the through-flow channel along II-II in FIG. 1 with a non-reduced (unshaded) and reduced (shaded) cross section;

FIG. 3 a representation of the control valve according to the disclosure showing a first embodiment in longitudinal section;

FIG. 4 a representation of the control valve according to the disclosure showing a second embodiment in longitudinal section.

### DETAILED DESCRIPTION OF THE PREFERRED EMBODIMENT

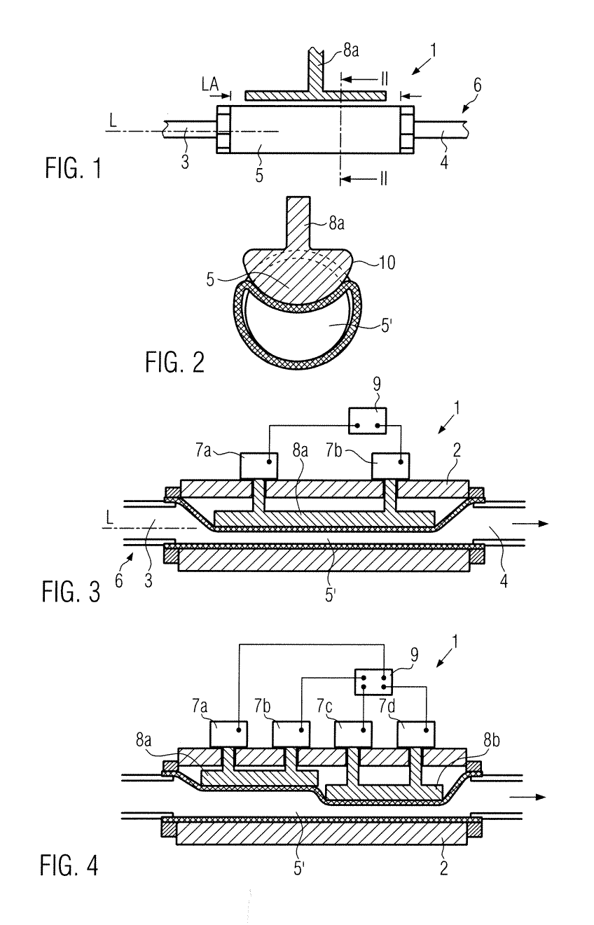

FIG. 1 shows a control valve 1 according to the disclosure. This control valve 1 has an inlet 3 and an outlet 4 and a channel located between the inlet 3 and outlet 4. The channel is formed as an elastic through-flow channel 5 which is coupled to the normal product line 6. The through-flow channel 5 has a line section LA, consisting of an elastic material, such as for example silicone rubber or PVC, and which is extended in its longitudinal axis L. The elastic through-flow channel 5 can thus be changed over a large line section LA with regard to its free line cross section, in particular however reduced.

FIG. 2 shows a cross-sectional representation of the elastic line section of the through-flow channel of a control valve according to the disclosure. The circular cross section of the through-flow region can be seen in the reduced (5′) and non-reduced (5) (shaded) states. The reduction in this representation is, for example, provided by a control piston 8a, which has a round piston area 10.

FIG. 3 illustrates a definitive embodiment of the control valve according to the disclosure. Two variable speed drives 7a and 7b can be seen, which are connected to the housing 2 by means of a mounting device (not illustrated). The reference numeral 9 designates the controller for controlling the variable speed drives. The two variable speed drives move a control piston 8a in the vertical direction relative to the through-flow channel.

The control piston 8a has a stamp-shaped body with a flat piston area 10 on its underside which is arranged orientated to the through-flow channel. The control piston and the piston area can also have a different shape however which is suitable for acting on the through-flow channel. Furthermore, it is also possible that a spring acts upwards against the gravitational effect on the control piston, i.e. the spring pressure presses the control piston away from the through-flow channel. It is only that the movement of the control piston presses the piston area 10 against the through-flow channel 5, whereby together with the housing 2 a force on the through-flow channel 5 is exerted which compresses the through-flow channel in the vertical direction. Correspondingly, the free line cross section is restricted.

FIG. 4 illustrates a further embodiment of the control valve according to the disclosure. Here too, as in the above case, the variable speed drives 7a-7d are arranged on the housing and connected to a common controller. In contrast to the embodiment illustrated in FIG. 2 however, here two extended control pistons 8a, 8b are arranged which can each be moved independently of one another by two variable speed drives. It can be seen that due to the independent movement of the control pistons a defined cross-sectional profile can be realized along the longitudinal direction of the through-flow channel.

1. Control valve (1) for pressure reduction, in particular for liquids containing solids, comprising an inlet, and an outlet, and a channel between the inlet and outlet, the channel being formed as an elastic through-flow channel with a free line cross section which can be reduced along its longitudinal axis over an extended line section.

2. The control valve according to claim 1, wherein the inlet, outlet and elastic through-flow channel are arranged in one housing.

3. The control valve according to claim 2, wherein the control valve has a control piston, which is extended along the longitudinal axis and which can be moved by at least one variable speed drive and is controlled by a controller.

4. The control valve according to claim 2, wherein the control valve has at least two control pistons (8a, 8b), which are extended along the longitudinal axis and which can each be moved independently of one another by at least one variable speed drive and are controlled by a controller.

5. The control valve according to one of the claim 3, wherein the control piston is movable vertically with respect to the through-flow channel, wherein, due to a movement of the control piston, the piston area interacts with the through-flow channel and the housing such that the free line cross section of the through-flow channel can be modified.

6. The control valve according to claim 1, wherein the line section has an internal diameter of 16-130 mm.

7. The control valve according to claim 1, wherein the line section has a length of 0.3-3 m.

8. The control valve according to claim 1, wherein the control valve is designed such that a pressure reduction of the product of up to 10 bar can be realized.

9. The control valve according to claim 1, wherein the control valve is designed such that a volume flow of up to 90 m3/h can be processed.

10. The control valve according to claim 3, wherein the control piston is moved by two variable speed drives.

11. The control valve according to claim 4 wherein each control piston is moved independently of one another by two variable speed drives.
